(19) United States
(12) Patent Application Publication
(10) Pub. No.: US 2024/0059880 A1
(43) Pub. Date: Feb. 22, 2024

(54) METALLOCENE POLYPROPYLENE COMPOSITIONS

(71) Applicant: FINA TECHNOLOGY, INC., Houston, TX (US)

(72) Inventors: Adrienne Music, Pasadena, TX (US); Fengkui Li, Houston, TX (US); Jon Tippet, League City, TX (US)

(21) Appl. No.: 18/234,634

(22) Filed: Aug. 16, 2023

Related U.S. Application Data
(60) Provisional application No. 63/398,336, filed on Aug. 16, 2022.

(51) Int. Cl. C08L 23/12; C08K 5/20; C08K 5/13; C08K 5/521

(52) U.S. Cl. CPC C08L 23/12; C08K 5/20; C08K 5/13; C08K 5/521; C08K 2201/014; C08L 2205/025

(57) ABSTRACT

A polymeric composition comprising at least 95 wt. % of a metallocene-catalyzed polypropylene, and at least one of a clarifying agent or a nucleating agent is disclosed. The polymeric composition can have a lower haze value when compared with a second polymeric composition that has the same components in the same wt. % amounts as the polymeric composition except that the polypropylene in the second polymeric composition is a Ziegler-Natta catalyzed polypropylene. The haze values can be determined by ASTM D1003 at a thickness of 50 mils.

### CROSS REFERENCE TO RELATED APPLICATIONS

The present application is a non-provisional application based on U.S. Provisional Application 63/398,336 filed Aug. 16, 2022.

### BACKGROUND OF THE INVENTION

### A. Field of the Invention

The invention generally concerns polypropylene compositions. In some aspects, clarifying and/or nucleating agents can be added to improve the clarity of the compositions when the polypropylene is a metallocene-catalyzed polypropylene. The improved clarifying effects of these agents can be demonstrated by comparing their clarifying effects in metallocene-catalyzed and non-metallocene-catalyzed polypropylenes.

### B. Description of Related Art

Polypropylene belongs to the family of polymers known as polyolefins and is one of the most widely-used polymers today. Polypropylene is typically considered a commodity chemical, with large volumes produced for the automotive industry, consumer goods, and the furniture industry. As polypropylene technology has improved, polypropylene applications have extended into specialty fields, like medical devices and aircraft components.

Polypropylene is made from polymerization of monomers of propene (C₃H₆), and typically involves the use of one of two catalyst types, a Ziegler-Natta or a metallocene catalyst. Each propene monomer includes a polymerizable element consisting of two carbon atoms with a double bond between them, and a pendant methyl group attached to one of the two carbon atoms. Monomer polymerizable elements chemically react with each other to provide a long hydrocarbon chain with one pendant methyl group present for every two carbon atoms in the chain.

Each propene monomer can be oriented in one of two ways when it polymerizes. As a result, the pendant methyl group attached to each propene monomer becomes secured in one of two orientations. The collective pattern in which the pendant methyl groups become oriented along the polymer chain leads to different basic chain structures. Isotactic polypropylene (iPP) has a uniform and recurring methyl group arrangement in which the methyl groups are oriented on one side of the polymer chain. Syndiotactic polypropylene (sPP) has a uniform and alternating methyl group arrangement in which the methyl groups are oriented on alternating sides of the polymer chain. Atactic propylene (aPP) has an irregular pendant methyl group arrangement with no orientation pattern. The overall orientation pattern of the pendant methyl groups affects the degree to which polymer chains can become aligned with one another, a property known as crystallinity.

Polypropylene is a semi-crystalline polymer that includes ordered regions with aligned polymer chains and amorphous regions that lack clearly defined shape or form. The organized or crystalline areas are called spherulites and can vary in shape and size with amorphous areas existing between the crystalline areas. The degree of crystallinity can affect characteristics of the polymer such as stiffness, as well as the chemical and thermal resistance of the material.

As polypropylene cools from a melted state to a solid state, spherulite nucleation is initiated around microscopic sites naturally present in the material. The spherulites continue to grow around nucleation sites and ultimately grow to become larger than the wavelength of visible light. Large spherulites scatter light and result in a material that appears hazy. A hazy appearance can be undesirable for applications like packaging, where visual appeal is a high priority. Polypropylene's haziness can be a limiting factor for its inclusion in end products wherein transparence is desired. This haziness can be more prevalent when the polypropylene has been formed (e.g., by injection molding) into an article of manufacture having an increased thickness when compared with thin films.

### SUMMARY OF THE INVENTION

A discovery has been made that provides a solution to the hazy appearance associated with some types of polypropylene. In one aspect, it was discovered that certain additives have different effects on polypropylene clarity, and the effects depend, in part, on the type of catalyst that was used to synthesize the polypropylene. In particular, it was discovered that additives such as nucleating agents and/or clarifying agents provide greater clarity when combined with metallocene-catalyzed polypropylene when compared with Ziegler-Natta catalyzed polypropylene. The clarifying effects of these additives was attenuated when combined with Ziegler-Natta catalyzed polypropylene. In some particular aspects, the clarifying agent can be a Nonitol-based clarifying agent (e.g., 1,2,3,4-dibenzylidene sorbitol, 1,2,3,4-di-para-methylbenzylidene sorbitol, 1,2,3,4-di-meta, para-methylbenzylidene sorbitol, or 1,2,3-trideoxy-4,5:5,7-bis-O-[(4-propylphenyl)methylene]-Nonitol) or a trisamide-based clarifying agent (e.g., 1,3,5-benzenetrisamide amide derivative, preferably 1,3,5-tri s(2,2-dimethyl propanamido)benzene). In some particular aspects, the nucleating agent can be a phosphate ester based nucleating agent (e.g., (Phosphate ester) 2,2′-methylenebis (4,6-di-tertbutylphenyl) phosphate optionally combined with a dispersant). As illustrated in a non-limiting manner in the Examples, such a combination of clarifying and/or nucleating agents with metallocene catalyzed polypropylenes surprisingly resulted in increased clarity when compared with Ziegler-Natta catalyzed polypropylenes. This improved clarity opens up a wide range of applications and/or uses for the metallocene-catalyzed polypropylene compositions of the present invention. For instance, the improved clarity can be particularly advantageous in applications where the polypropylene polymer has been formed (e.g., by injection molding) into an article of manufacture that has a thickness of at least 2 mil, preferably at least 5 mil, more preferably at least 10 mil, or even more preferably 20 mil to 300 mil, or even more preferably 20 mil to 100 mil.

In one aspect of the present invention, there is disclosed a polymeric composition comprising at least 95 wt. % of a metallocene-catalyzed polypropylene and at least one of a clarifying agent or a nucleating agent, wherein the polymeric composition has a lower haze value when compared with a second polymeric composition that has the same components in the same wt. % amounts as the polymeric composition except that the polypropylene in the second polymeric composition is a Ziegler-Natta catalyzed polypropylene, and wherein the haze value is determined by ASTM D1003 at a thickness of 50 mils. Other thicknesses can also be used to test and compare haze values (e.g., 5, 10, 15, 20, 25, 30, 35, 40, 45, 55, 60, 65, 70, 75, or 80 mils). In some aspects, the % difference between the haze values of the polymeric composition and the second polymeric composition increases with increasing amounts of the at least one clarifying agent or the at least one nucleating agent. The polymeric composition may include 0.02 wt. % to 0.4 wt. % of the at least one clarifying agent or nucleating agent. In some particular aspects, the clarifying agent can be present at preferably 0.2 wt. % to 0.4 wt. % (or any range or number therein, e.g., 0.2, 0.3, or 0.4 wt. %). In some particular aspects, the nucleating agent can be present at preferably 0.02 wt. % to 0.2 wt. % (or any range or number therein, e.g., 0.02, 0.03, 0.04, 0.05, 0.06, 0.07, 0.08, 0.09, 0.1, or 0.2 wt. %).

When correlating the haze to the amount of at least one clarifying agent or nucleating agent in both polymeric compositions, the compositions may exhibit one or more of the following characteristics. When both the polymer composition and the second polymeric composition have 0.1 wt. % of the at least one clarifying agent or nucleating agent, the percentage difference between the haze values of the polymeric composition and the second polymeric composition can be 10% to 25%. When both the polymer composition and the second polymeric composition have 0.2 wt. % of the at least one clarifying agent or nucleating agent, the percentage difference between the haze values of the polymeric composition and the second polymeric composition can be 45% to 60%. When both the polymer composition and the second polymeric composition have 0.4 wt. % of the at least one clarifying agent or nucleating agent, the percentage difference between the haze values of the polymeric composition and the second polymeric composition can be 90% to 105%. A preferred thickness to measure these haze values is on 50 mil molded plaques. However, and as indicated above, other thicknesses can be used to test haze values.

In some aspects, the metallocene-catalyzed polypropylene and the Ziegler-Natta catalyzed polypropylene are each a homopolymer. In other aspects, the metallocene-catalyzed polypropylene and the Ziegler-Natta catalyzed polypropylene are each a random copolymer. In further aspects, the metallocene-catalyzed polypropylene and the Ziegler-Natta catalyzed polypropylene are a blend of a homopolymer and a copolymer.

In some aspects, the polymeric composition comprises the at least one clarifying agent. In further aspects, the clarifying agent is a Nonitol-based clarifying agent or a trisamide-based clarifying agent. In particular aspects, the Nonitol-based clarifying agent is 1,2,3,4-dibenzylidene sorbitol, 1,2,3,4-di-para-methylbenzylidene sorbitol, 1,2,3,4-di-meta, para-methylbenzylidene sorbitol, or 1,2,3-trideoxy-4,5:5,7-bis-O-[(4-propylphenyl)methylene]-Nonitol. In other aspects, the trisamide-based clarifying agent is a 1,3,5-benzenetrisamide amide derivative, preferably 1,3,5-tris(2,2-dimethyl propanamido)benzene. In some aspects, the clarifying agent is 1,2,3-trideoxy-4,5:5,7-bis-O-[(4-propylphenyl)methylene]-Nonitol.

In some aspects, the polymeric composition comprises the at least one nucleating agent. In particular aspects, the nucleating agent is a phosphate ester based nucleating agent. In a particular embodiment, the phosphate ester based nucleating agent includes (Phosphate ester) 2,2′-methylenebis (4,6-di-tertbutylphenyl) phosphate. In some aspects, a dispersant can be included in the phosphate ester based nucleating agent.

In some aspects, the polymeric composition has a melt flow index of 0.2 to 150 g/10 min as measured by ASTM D1238 (230° C./2.16 kg). In further aspects, the polymeric composition has a melt flow index of 5 to 100 g/10 min, preferably about 20-30 g/10 min, and a second polymeric composition with the same components in the same wt. % amounts as the polymeric composition except that the polypropylene in the second polymeric composition is a Ziegler-Natta catalyzed polypropylene, has a melt flow index of 5 to 100 g/10 min, preferably about 25-35 g/10 min.

In some aspects, the polymeric composition further comprises an additive. The additive can be an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer, a fire retardant, a mold release agent, a dye, a blowing agent, a fluorescent agent, a surfactant, or any combination thereof.

In some aspects, the first polypropylene composition can include an elongation of 1% to 20%, preferably 3% to 10%, or more preferably about 7% as measured by ASTM D3218 and/or a melting point of 125° C. to 175° C., preferably 140° C. to 160° C., or more preferably about 151° C. as measured by differential scanning calorimetry (DSC). The second polymeric composition can include an elongation of 5% to 20%, preferably 10% to 15%, or more preferably about 12% as measured by ASTM D638 and/or a melting point of 125° C. to 200° C., preferably 150° C. to 175° C., or more preferably about 165° C. as measured by differential scanning calorimetry (DSC).

In some aspects of the present invention, the metallocene-catalyzed polypropylene composition, the Zeigler-Natta-catalyzed polypropylene composition, and/or articles of manufacture formed from or comprising the metallocene-catalyzed or Zeigler-Natta-catalyzed compositions can have a thickness of at least 2 mil, 3, mil, 4 mil, 5 mil, 6 mil, 7 mil, 8 mil, 9 mil, 10 mil, 15 mil, 20 mil, 25, mil, 30 mil, 35 mil, 40 mil, 45 mil, 50 mil, 55 mil, 60 mil, 65 mil, 70 mil, 75 mil, 80 mil, 85 mil, 90 mil, 95 mil, 100 mil, 110 mil, 120 mil, 130 mil, 140 mil, 150 mil, 160 mil, 170 mil, 180 mil, 190 mil, 200 mil, 210 mil, 220 mil, 230 mil, 240 mil, 250 mil, 260 mil, 270 mil, 280 mil, 290 mil, 300 mil, 350 mil, 400 mil, or 500 mil, or greater or any range or number therein (e.g., a thickness of at least 5 mil, at least 10 mil, 20 mil to 300 mil, 20 mil to 100 mil, 40 mil to 100 mil, 40 mil to 80 mil, etc.). In some preferred aspects, the thickness of the polypropylene compositions or articles of manufacture of the present invention can be 20 mil to 100 mil.

Also disclosed in the context of the present invention is an article of manufacture that includes the polymeric composition of the present invention. In some aspects, a method of making the article of manufacture comprises obtaining the polymeric composition and making the article of manufacture by injection molding, blow molding, compression molding, stretch molding, rotational molding, transfer molding, sheet extrusion thermoforming, shallow-draw thermoforming, deep-draw thermoforming, or profile extrusion.

Also disclosed is a method for producing the polypropylene composition of the present invention. The method can include obtaining a composition comprising at least 95 wt. % of the polypropylene and a clarifying agent and/or a nucleating agent, and extruding the composition to obtain the polypropylene composition. In some aspects, the extrusion conditions include a temperature of 200° C. to 260° C.

Also disclosed in the context of the present invention are aspects 1-24. Aspect 1 is a polymeric composition comprising: (a) at least 95 wt. % of a metallocene-catalyzed polypropylene; and (b) at least one of a clarifying agent or a nucleating agent, wherein the polymeric composition has a lower haze value when compared with a second polymeric composition that has the same components in the same wt. % amounts as the polymeric composition except that the polypropylene in the second polymeric composition is a Ziegler-Natta catalyzed polypropylene, and wherein the haze value is determined by ASTM D1003 at a thickness of 50 mils. Aspect to is the polymeric composition of aspect 1, wherein the % difference between the haze values of the polymeric composition and the second polymeric composition increases with increasing amounts of the at least one clarifying agent or the at least one nucleating agent. Aspect 3 is the polymeric composition of aspect 2, wherein the polymeric composition includes 0.02 wt. % to 0.4 wt. % of the at least one clarifying agent and/or of the at least one nucleating agent, preferably 0.2 wt. % to 0.4 wt. % of the at least one clarifying agent and/or preferably 0.02 wt. % to 0.2 wt. % of the at least one nucleating agent. Aspect 4 is the polymeric composition of aspect 3, wherein: the percentage difference between the haze values of the polymeric composition and the second polymeric composition is 10% to 25% when both polymeric compositions have 0.1 wt. % of the at least one clarifying agent or nucleating agent; the percentage difference between the haze values of the polymeric composition and the second polymeric composition is 45% to 60% when both polymeric compositions have 0.2 wt. % of the at least one clarifying agent or nucleating agent; and/or the percentage difference between the haze values of the polymeric composition and the second polymeric composition is 90% to 105% when both polymeric compositions have 0.4 wt. % of the at least one clarifying agent or nucleating agent. Aspect 5 is the polymeric composition of any one of aspects 1 to 4, wherein the metallocene-catalyzed polypropylene and the Ziegler-Natta catalyzed polypropylene are each a homopolymer. Aspect 6 is the polymeric composition of any one of aspects 1 to 4, wherein the metallocene-catalyzed polypropylene and the Ziegler-Natta catalyzed polypropylene are each a random copolymer. Aspect 7 is the polymeric composition of any one of aspects 1 to 4, wherein the metallocene-catalyzed polypropylene and the Ziegler-Natta catalyzed polypropylene are a blend of a homopolymer and a copolymer. Aspect 8 is the polymeric composition of any one of aspects 1 to 7, wherein the polymeric composition comprises the at least one clarifying agent. Aspect 9 is the polymeric composition of aspect 8, wherein the clarifying agent is a Nonitol-based clarifying agent or a trisamide-based clarifying agent. Aspect 10 is the polymeric composition of aspect 9, wherein: the Nonitol-based clarifying agent is 1,2,3,4-dibenzylidene sorbitol, 1,2,3,4-di-para-methylbenzylidene sorbitol, 1,2,3,4-di-meta, para-methylbenzylidene sorbitol, or 1,2,3-trideoxy-4,5:5,7-bis-O-[(4-propylphenyl)methylene]-Nonitol, or the trisamide-based clarifying agent is a 1,3,5-benzenetrisamide amide derivative, preferably 1,3,5-tris(2,2-dimethyl propanamido)benzene. Aspect 11 is the polymeric composition of aspect 10, wherein the clarifying agent is 1,2,3-trideoxy-4,5:5,7-bis-O-[(4-propylphenyl)methylene]-Nonitol. Aspect 12 is the polymeric composition of any one of aspects 1 to 11, wherein the polymeric composition comprises the at least one nucleating agent. Aspect 13 is the polymeric composition of aspect 12, wherein the nucleating agent is a phosphate ester based nucleating agent. Aspect 14 is the polymeric composition of aspect 13, wherein the nucleating agent comprises (Phosphate ester) 2,2′-methylenebis (4,6-di-tertbutylphenyl) phosphate and optionally a dispersant. Aspect 15 is the polymeric composition of any one of aspects 1 to 14, wherein the polymeric composition has a melt flow index of 0.2 to 150 g/10 min as measured by ASTM D1238 (230° C./2.16 kg). Aspect 16 s the polymeric composition of aspect 15, wherein the polymeric composition has a melt flow index of 5 to 100 g/10 min, preferably about 20-30 g/10 min, and the second polymeric composition has a melt flow index of 5 to 100 g/10 min, preferably about 25-35 g/10 min. Aspect 17 is the polymeric composition of any one of aspects 1 to 16, wherein the polymeric composition further comprises an additive, wherein the additive is an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer, a fire retardant, a mold release agent, a dye, a blowing agent, a fluorescent agent, a surfactant, or any combination thereof. Aspect 18 is the polymeric composition of any one of aspects 1 to 17, wherein: the polymeric composition has at least one of the following properties: an elongation of 1% to 20%, preferably 3% to 10%, or more preferably about 7% as measured by ASTM D3218; and/or a melting point of 125° C. to 175° C., preferably 140° C. to 160° C., or more preferably about 151° C. as measured by differential scanning calorimetry (DSC); and/or the second polymeric composition has at least one of the following properties: an elongation of 5% to 20%, preferably 10% to 15%, or more preferably about 12% as measured by ASTM D638; and/or a melting point of 125° C. to 200° C., preferably 150° C. to 175° C., or more preferably about 165° C. as measured by differential scanning calorimetry (DSC). Aspect 19 is the polymeric composition of any one of aspects 1 to 18, wherein the polymeric composition has a thickness of at least 2 mil, preferably at least 5 mil, more preferably at least 10 mil, or even more preferably 20 mil to 300 mil, or even still more preferably 20 mil to 100 mil. Aspect 20 is an article of manufacture comprising the polymeric composition of any one of aspects 1 to 19. Aspect 21 is the article of manufacture of aspect 20, wherein the article of manufacture is an injection molded article of manufacture, preferably having a thickness of 20 mil to 100 mil.

Aspect 22 is a method of making the article of manufacture of aspect 21, the method comprising obtaining the polymeric composition of any one of aspects 1 to 19 and making the article of manufacture by injection molding, blow molding, compression molding, stretch molding, rotational molding, transfer molding, sheet extrusion thermoforming, shallow-draw thermoforming, deep-draw thermoforming, or profile extrusion. Aspect 23 is a method of producing the polypropylene composition of any one of aspects 1 to 19, the method comprising: (a) obtaining a composition comprising: at least 95 wt. % of the polypropylene; and a clarifying agent or a nucleating agent; and (b) extruding the composition to obtain the polypropylene composition of any one of aspects 1-19. Aspect 24 is the method of aspect 23, wherein the extrusion conditions include a temperature of 200° C. to 260° C.

Other aspects or embodiments of the invention are discussed throughout this application. Any aspect or embodiment discussed with respect to one aspect of the invention applies to other aspects or embodiments of the invention as well and vice versa. Each aspect or embodiment described herein is understood to be aspects or embodiments of the invention that are applicable to other aspects of the invention. It is contemplated that any aspect or embodiment discussed herein can be combined with other aspects or embodiments discussed herein and/or implemented with respect to any method or composition of the invention, and vice versa. Furthermore, compositions and systems of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, alternatively within 5%, alternatively within 1%, and alternatively within 0.5%.

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The terms “ppm” refer to parts per million by weight of a component, based on the total weight, that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification include any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, X, Y, and/or Z can include: X alone, Y alone, Z alone, a combination of X and Y, a combination of X and Z, a combination of Y and Z, or a combination of X, Y, and Z.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process and systems of the present invention can “comprise,” “consist essentially of,” or “consist of” particular ingredients, components, compositions, steps, etc., disclosed throughout the specification. With respect to the transitional phrase “consisting essentially of,” in one non-limiting aspect, a basic and novel characteristic of the compositions and processes of the present invention include the use of nucleators and clarifying agents to improve the clarity of metallocene-catalyzed polypropylene compositions when compared with Ziegler-Natta-catalyzed polypropylene compositions.

Other objects, features and advantages of the present invention will become apparent from the following detailed description and examples. It should be understood, however, that the detailed description and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### DETAILED DESCRIPTION OF THE INVENTION

One aspect of the present invention is based on a discovery that clarifying agents and/or nucleating agents provide a targeted improvement in clarity in metallocene-catalyzed polypropylene compositions. The improvement in clarity is surprising and unexpected in that the degree to which clarity is improved is greater than in other polypropylene compositions, e.g., Ziegler-Natta-catalyzed compositions. In side-by-side comparisons of polypropylene compositions produced using different catalysts, the addition of a clarifying agent or a nucleating agent selectively imparted lower haze in the metallocene-catalyzed polypropylenes. Non-limiting data in the Examples section confirms this discovery. These and other non-limiting aspects of the present invention are discussed in further detail in the following sections.

### A. Polypropylene

The polypropylene polymers can include homopolymers (e.g., isotactic, syndiotactic, atactic polypropylene) of polypropylene, copolymers of propylene and other olefins, and terpolymers of propylene, ethylene, and/or dienes. In some instances, a controlled rheology grade polypropylene (CRPP) can be used. A CRPP is one that has been further processed (e.g., through a degradation process) to produce a polypropylene polymer with a targeted high melt flow index (MFI), lower molecular weight, and/or a narrower molecular weight distribution than the starting polypropylene.

Polypropylene can be prepared by any of the polymerization processes, which are in commercial use (e.g., a “high pressure” process, a slurry process, a solution process and/or a gas phase process). Polypropylene can be prepared using methods described in U.S. Pat. Nos. 8,957,159, 8,088,867, 8,071,687, 7,056,991 and 6,653,254. The polypropylene can also be purchased through a commercial source such as those from TotalEnergies (USA), Total SA, LyondellBasell Industries, Reliance Industries Ltd, Sinopec, and ExxonMobil Chemical Co. The polypropylene can be in previously extruded and/or be in solid form, for example, pellets. A non-limiting example of a polypropylene polymer that can be used in the present invention is M3766, a metallocene-catalyzed polypropylene homopolymer having a melt index (2.16 kg-230° C.) of 24 g/10 min, as determined by ASTM D-1238, a density of 0.9 g/cc, as determined by ASTM D-1505, and a melting point of 151° C. (304° F.), as determined by differential scanning calorimetry. A non-limiting example of a polypropylene polymer that can be used to validate the effectiveness of clarifying and nucleating additives in metallocene-catalyzed polypropylenes is 3825, a Ziegler-Natta-catalyzed polypropylene homopolymer having a melt index (2.16 kg-230° C.) of 30 g/10 min, as determined by ASTM D-1238, a density of 0.9 g/cc, as determined by ASTM D-1505, and a melting point of 165° C. (330° F.), as determined by differential scanning calorimetry.

### B. First Polypropylene Composition (Metallocene-Catalyzed Polypropylene Composition)

The first polypropylene composition can contain at least 95 wt. % of a metallocene-catalyzed polypropylene and at least one of a clarifying agent and a nucleating agent. The first polypropylene composition can include 95 wt. % to 100 wt. %, or equal to any one of, at least any one of, at most any one of, or between any two of 95, 96, 97, 98, 99, 99.1, 99.2, 99.3, 99.4, 99.5, 99.6, 99.7, 99.8 and 99.9, 99.95 and 100 wt. % of the polypropylene based on the total weight of the first composition. The polypropylene in the first polypropylene composition can be a homopolymer, a random copolymer, or a blend of a homopolymer and a copolymer. In certain aspects, the first polypropylene composition has a melt flow index of 5 to 100 g/10 min, preferably about 20-30 g/10 min. In certain aspects, the first polypropylene composition can have, any one of, any combination of, or all of i) an elongation of 1% to 20%, preferably 3% to 10%, or more preferably about 7% as measured by ASTM D3218 and ii) a melting point of 125° C. to 175° C., preferably 140° C. to 160° C., or more preferably about 151° C. as measured by differential scanning calorimetry (DSC).

### C. Second Comparative Polypropylene Composition (Zeigler-Natta-Catalyzed Polypropylene Composition)

The second polypropylene composition is a comparative composition that can be used to compare the anti-haze effect of a clarifying agent or a nucleating agent on different polypropylene compositions. The second polypropylene composition can be a Ziegler-Natta catalyzed polypropylene. In some aspects, the second polymeric composition has the same components in the same wt. % amounts as the first polymeric composition, except that the polypropylene in the second polymeric composition is a Ziegler-Natta catalyzed polypropylene. The polypropylene in the second polypropylene composition can be a homopolymer, a random copolymer, or a blend of a homopolymer and a copolymer. In certain aspects, the second polypropylene composition has a melt flow index of 5 to 100 g/10 min, preferably about 25-35 g/10 min. In certain aspects, the second polypropylene composition can have, any one of, any combination of, or all of i) an elongation of 5% to 20%, preferably 10% to 15%, or more preferably about 12% as measured by ASTM D3218 and ii) a melting point of 125° C. to 200° C., preferably 150° C. to 175° C., or more preferably about 165° C. as measured by differential scanning calorimetry (DSC).

### D. Clarifying Agents

Polypropylene compositions of the present invention can include a clarifying agent or a combination of clarifying agents. The clarifying agent can include a trisamide-based clarifier, a nonitol-based clarifier, and/or a sorbitol-based clarifier, or any combination thereof. Trisamide clarifiers include, but are not limited to, amide derivatives of benzene-1,3,5-tricarboxylic acid, amide derivatives of 1,3,5-benzenetriamine, derivatives of N-(3,5-bis-formylamino-phenyl)-formamide, derivatives of 2-carbamoyl-malonamide, and combinations thereof. In certain aspects the trisamide clarifier is N,N′,N″-benzene-1,3,5-triyltris(2,2-dimethylpropanamide). Nonitol-based clarifies include, but are not limited to, derivatives of nonitol, an example of which includes 1,2,3-trideoxy-4,5:5,7-bis-O-[(4-propylphenyl)methylene]-Nonitol (NX8000, CAS Reg. No. 882073-43-0, Milliken Chemical, Spartanburg, S.C.). Sorbitol clarifiers include, but are not limited to 1,2,3,4-dibenzylidene sorbitol (Millad 3905, CAS #: 32647-67-9, Milliken Chemical, Spartanburg, S. C.), 1,2,3,4-di-para-methylbenzylidene sorbitol (Millad 3940 CAS #: 54686-97-4, Milliken Chemical, Spartanburg, S.C.), and 1,2,3,4-di-meta, para-methylbenzylidene sorbitol (Millad 3998, CAS #: 135861-56-2, Milliken Chemical, Spartanburg, S.C.). Another clarifier that can be used in the context of the present invention includes NA-71 (ADK STAB NA-71) (Adeka Corporation, Tokyo, Japan). In some preferred aspects, the clarifier is 1,2,3-trideoxy-4,5:5,7-bis-0-[(4-propylphenyl)methylene]-Nonitol (NX8000, CAS Reg. No. 882073-43-0, Milliken Chemical, Spartanburg, S.C.). In other preferred aspects, the clarifier is a 1,3,5-benzenetrisamide amide derivative, preferably 1,3,5-tris(2,2-dimethyl propanamido)benzene (Irgacelar XT 386, BASF, Ludwigshafen, Germany).

In some preferred aspects, the clarifier is a Nonitol-based clarifier, preferably, 1,2,3-trideoxy-4,5:5,7-bis-O-[(4-propylphenyl)methylene]-Nonitol (NX8000, CAS Reg. No. 882073-43-0, Milliken Chemical, Spartanburg, S.C.).

The amount of clarifying agents that can be included in the polypropylene compositions of the present invention include 0.01 wt. % to 5 wt. % or any amount or range therein (e.g., 0.01 wt. %, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %). In some preferred aspects, the polypropylene compositions of the present invention can include 0.01 wt. % to 0.5 wt. % of the clarifying agent(s) or any amount or range therein (e.g., 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, or 0.5 wt. %).

### E. Nucleating Agents

Polypropylene compositions of the present invention can include a nucleating agent or a combination of nucleating agents. The nucleating agent can include a phosphate ester based nucleating agent. Non-limiting examples of phosphate ester based nucleating agents include 2,2′-methylenebis (4,6-di-tertbutylphenyl) phosphate or Hyperform HPN 715 (Milliken Chemical, Spartanburg, S.C.). 2,2′-methylenebis (4,6-di-tertbutylphenyl) phosphate is also commercially available from Adeka (Tokyo, Japan) under the tradenames ADK STAB NA-11 or ADK STAB NA-27. NA-27 is NA-11 in combination with a dispersant. In other instances, the nucleating agent can be a non-phosphate ester based nucleating agent (e.g., bicyclo[2.2.1]heptane-2,3-dicarboxylic acid disodium salt or Hyperform HPN 68L (Milliken Chemical, Spartanburg, S.C.)).

The amount of nucleating agents that can be included in the polypropylene compositions of the present invention include 0.01 wt. % to 5 wt. % or any amount or range therein (e.g., 0.01 wt. %, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %). In some preferred aspects, the polypropylene compositions of the present invention can include 0.01 wt. % to 0.5 wt. % of the nucleating agent or any amount or range therein (e.g., 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, or 0.5 wt. %).

### F. Additives

The first and second polypropylene compositions of the present invention can include various additives. Non-limiting examples of additives include a dispersant, an antiblocking agent, an antistatic agent, an antioxidant, a neutralizing agent, an antistatic agent, an antifog agent, an anticorrosion agent, a lubricant, a plasticizer, a mineral oil, a wax, a clay, talc, calcium carbonate, diatomaceous earth, carbon black, mica, glass fibers, a blowing agent, a crystallization aid, a dye, a flame retardant, a filler, an impact modifier, a mold release agent, an oil, another polymer, a dye, a pigment, a processing agent, a reinforcing agent, a slip agent, a fluorescent agent, a surfactant, a fire retardant, a flow modifier, a stabilizer, an UV resistance agent, and combinations thereof. Additives are available from various commercial suppliers. Non-limiting examples of commercial additive suppliers include BASF (Germany), Dover Chemical Corporation (U.S.A.), AkzoNobel (The Netherlands), Sigma-Aldrich® (U.S.A.), Atofina Chemicals, Inc., and the like. The amount of additives can range from 0.01 wt. % to 5 wt. % (e.g., 0.01 wt. %, 0.05 w.t %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %, or any value or range there between) in the first polypropylene composition and/or the second polypropylene composition. In some aspects, the additive(s) and additive amount(s) added to the first polypropylene composition should be the same as the additive(s) and additive amount(s) added to the second polypropylene composition in order to control for disparate additive/amount effects.

### G. Method of Making the Polymeric Compositions

The first and second polymeric compositions of the present invention can be made by blending the polypropylene (metallocene-catalyzed polypropylene for the first composition and Zeigler-Natta-catalyzed polypropylene for the second composition) with the clarifying and/or nucleating agents and optionally with other additives together. In some aspects, the polypropylene can be in a solid form (e.g., pellets) and can be melted and mixed with the clarifying and/or nucleating agents and optional other additives. Suitable blending machines are known to those skilled in the art. Non-limiting examples include mixers, kneaders, and extruders. In certain aspects, the process can be carried out with an extruder by introducing the polypropylene and clarifying and/or nucleating agents and other additives to the extruder hopper. Non-limiting examples of an extruder includes single-screw extruders, contrarotating and co-rotating twin-screw extruders, planetary-gear extruders, ring extruders, or co-kneaders. The melt blending can be performed at a melt temperature of 200° C. to 260° C., or equal to any one of, at most any one of, or between any two of 200° C., 205° C., 210° C., 215° C., 220° C., 225° C., 230° C., 235° C., 240° C., 245° C., 250° C., 255° C., and 260° C. The polypropylene and the clarifying and/or nucleating agents and other additives can be subjected to an elevated temperature for a sufficient period of time during blending. The blending temperature can be above the softening point of the polypropylene.

The clarifying and/or nucleating agents and other additives can be premixed or added individually to the polypropylene. By way of example, the clarifying and/or nucleating agents and other additives can be premixed such that they are added to the polypropylene. Incorporation of clarifying and nucleating agents and other additives into the polypropylene can be carried out, for example, by mixing the above-described components using methods customary in process technology. The blending temperature can be above the softening point of the polypropylene. In certain aspects, a process can be performed at a temperature from about 160° C. to 250° C. Such “melt mixing” or “melt compounding” results in uniform dispersion of the present additives in the polypropylene.

### H. Articles of Manufacture

The polymeric composition of the present invention can be included in an article of manufacture. In some aspects, the article of manufacture can be an extruded, a blow-molded, rotational-molded, an injection-molded, and/or thermoformed article. In some aspects, the article of manufacture can be transparent. Non-limiting examples of articles of manufacture can include, films, sheets, fibers, yarns, a packing filing, a forming film, a protective packaging, a shrink sleeve, and/or label, a shrink film, a twist wrap, a sealant film, a cap, a crate, a bottle, a jar, a funnel, a pipette tip, a well plate, a microtiter plate, a syringe, a suture, a face mask, personal protective equipment, a medical tool, a medical tray, a sample vial, a cuvette, a reaction vial, contact lens mold, a cigarette filter, a technical filter, woven socks, cold and warm weather sport clothing, undergarments, shoes, ropes, twines, bale wrapper, tape, construction/industrial fabrics, piping, non-electric fuses for initiating explosives, absorbent products (e.g., diapers), expandable foams, carpets, mats, rugs, furniture, toys, luggage, tote bags, duffle bags, sport bags backpacks, fabrics, food containers, food lids, deli containers and lids, dairy containers and lids, vehicle parts, dashboards, bumpers, cladding, exterior trim, film cushioning, film skins, covers, interior vehicle elements. In these and other uses the resins may be combined with other materials, such as particulate materials, including talc, calcium carbonate, wood, and fibers, such as glass or graphite fibers, to form composite materials. Examples of such composite materials include components for furniture, automotive components, and building materials, particularly those used as lumber replacement.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### A. Example 1—(Preparation of Ziegler-Natta-Catalyzed Polypropylene Composition with Nucleator)

The polypropylene composition of Example 1 was made by directly adding a nucleator (NA27, 0.1 wt. %) to a Ziegler-Natta-catalyzed polypropylene (3825, 99.9 wt. %) and blending the two materials together with a 1¼ inch Welex extruder at 30 pph rate with a melt temperature of 400° F.

### B. Example 2—(Preparation of Metallocene-Catalyzed Polypropylene Composition with Nucleator)

The polypropylene composition of Example 2 was made by directly adding a nucleator (NA27, 0.1 wt. %) to a metallocene-catalyzed polypropylene (M3766, 99.9 wt. %) and blending the two materials together with a 1¼ inch Welex extruder at 30 pph rate with a melt temperature of 400° F.

### C. Example 3—(Preparation of Ziegler-Natta-Catalyzed Polypropylene Composition with Clarifying Agent)

The polypropylene composition of Example 3 was made by directly adding a clarifying agent (NX8000, 0.2 wt. %) to a Ziegler-Natta-catalyzed polypropylene (3825, 99.8 wt. %) and blending the two materials together with a 1¼ inch Welex extruder at 30 pph rate with a melt temperature of 400° F.

### D. Example 4—(Preparation of Metallocene-Catalyzed Polypropylene Composition with Clarifying Agent)

The polypropylene composition of Example 4 was made by directly adding a clarifying agent (NX8000, 0.2 wt. %) to a metallocene-catalyzed polypropylene (M3766, 99.8 wt. %) and blending the two materials together with a 1¼ inch Welex extruder at 30 pph rate with a melt temperature of 400° F.

### E. Example 5—(Preparation of Ziegler-Natta-Catalyzed Polypropylene Composition with Clarifying Agent)

The polypropylene composition of Example 5 was made by directly adding a clarifying agent (NX8000, 0.4 wt. %) to a Ziegler-Natta-catalyzed polypropylene (3825, 99.6 wt. %) and blending the two materials together with a 1¼ inch Welex extruder at 30 pph rate with a melt temperature of 400° F.

### F. Example 6—(Preparation of Metallocene-Catalyzed Polypropylene Composition with Clarifying Agent)

The polypropylene composition of Example 6 was made by directly adding a clarifying agent (NX8000, 0.4 wt. %) to a metallocene-catalyzed polypropylene (M3766, 99.6 wt. %) and blending the two materials together with a 1¼ inch Welex extruder at 30 pph rate with a melt temperature of 400° F.

### G. Example 7—(Haze Vales of the Example 1-6 Compositions)

Tables 1 and 2 provide data concerning the haze values of the Example 1-6 polypropylene compositions.

TABLE 1
Example Compositions

| | | | Additive |
|---|---|---|---|
| | | | Amount |
| Example No. | Polymer Type | Additive Type | (wt. %) |
| Example 1 | Ziegler-Natta-catalyzed | nucleator | 0.1% |
| Example 2 | metallocene-catalyzed | nucleator | 0.1% |
| Example 3 | Ziegler-Natta-catalyzed | clarifying agent | 0.2% |
| Example 4 | metallocene-catalyzed | clarifying agent | 0.2% |
| Example 5 | Ziegler-Natta-catalyzed | clarifying agent | 0.4% |
| Example 6 | metallocene-catalyzed | clarifying agent | 0.4% |

TABLE 2
Haze Values

| Example No. | 1 | 2 | 3 | 4 | 5 | 6 |
|---|---|---|---|---|---|---|
| Haze % | 46.1 | 38.8 | 30.8 | 18.0 | 15.4 | 5.4 |
| Std. Dev. % | 1.8 | 0.5 | 1.4 | 1.9 | 0.5 | 0.7 |

Table 1 portrays the various polypropylene compositions that were prepared. The polypropylene compositions include either a metallocene-catalyzed polypropylene or a Ziegler-Natta-catalyzed polypropylene in combination with various amounts of either a clarifying agent or a nucleating agent. The compositions were molded into 50 mil thick lids then examined for haze.

Table 2 includes the haze values for the various polypropylene compositions. Comparison of Examples 1 and 2 show that equal amounts of a nucleator provided higher clarity (i.e., lower haze) in the metallocene-catalyzed material. Comparison of Examples 3 and 4 show that equal amounts of clarifying agent also delivered higher clarity in the metallocene-catalyzed materials. A greater improvement in clarity of the metallocene-catalyzed material was also observed when comparing Examples 5 and 6.

Comparison of metallocene-catalyzed Examples 4 and 6 show that higher clarifier loading resulted in higher clarity. The net fractional reduction in haze between Examples 5 and 6 (w/0.4% clarifier) is greater than the corresponding fractional haze reduction observed between Examples 3 and 4 (w/0.2% clarifier). These results indicate that the improvement in clarity is more drastic as the concentration of additive is increased (from 0.2% to 0.4%). Together, the results show that a significant clarifying effect is observed when a nucleator or clarifying additive is used in metallocene-catalyzed polypropylene compositions. The clarifying effects are greater in metallocene-catalyzed polypropylene compositions than in Ziegler-Natta-catalyzed polypropylene compositions.

Although embodiments of the present application and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A polymeric composition comprising:
(a) at least 95 wt. % of a metallocene-catalyzed polypropylene; and
(b) at least one of a clarifying agent or a nucleating agent,
wherein the polymeric composition has a lower haze value when compared with a second polymeric composition that has the same components in the same wt. % amounts as the polymeric composition except that the polypropylene in the second polymeric composition is a Ziegler-Natta catalyzed polypropylene, and wherein the haze value is determined by ASTM D1003 at a thickness of 50 mils.

2. The polymeric composition of claim 1, wherein the % difference between the haze values of the polymeric composition and the second polymeric composition increases with increasing amounts of the at least one clarifying agent or the at least one nucleating agent.

3. The polymeric composition of claim 2, wherein the polymeric composition includes 0.02 wt. % to 0.4 wt. % of the at least one clarifying agent and/or of the at least one nucleating agent.

4. The polymeric composition of claim 3, wherein the percentage difference between the haze values of the polymeric composition and the second polymeric composition is 10% to 25% when both polymeric compositions have 0.1 wt. % of the at least one clarifying agent or nucleating agent, the percentage difference between the haze values of the polymeric composition and the second polymeric composition is 45% to 60% when both polymeric compositions have 0.2 wt. % of the at least one clarifying agent or nucleating agent, and/or
the percentage difference between the haze values of the polymeric composition and the second polymeric composition is 90% to 105% when both polymeric compositions have 0.4 wt. % of the at least one clarifying agent or nucleating agent.

5. The polymeric composition of claim 1, wherein the metallocene-catalyzed polypropylene and the Ziegler-Natta catalyzed polypropylene are each a homopolymer.

6. The polymeric composition of claim 1, wherein the metallocene-catalyzed polypropylene and the Ziegler-Natta catalyzed polypropylene are each a random copolymer.

7. The polymeric composition of claim 1, wherein the metallocene-catalyzed polypropylene and the Ziegler-Natta catalyzed polypropylene are a blend of a homopolymer and a copolymer.

8. The polymeric composition of claim 1, wherein the polymeric composition comprises the at least one clarifying agent.

9. The polymeric composition of claim 8, wherein the clarifying agent is a Nonitol-based clarifying agent or a trisamide-based clarifying agent.

10. The polymeric composition of claim 9, wherein the Nonitol-based clarifying agent is 1,2,3,4-dibenzylidene sorbitol, 1,2,3,4-di-para-methylbenzylidene sorbitol, 1,2,3,4-di-meta, para-methylbenzylidene sorbitol, or 1,2,3-trideoxy-4,5:5,7-bis-O-[(4-propylphenyl)methylene]-Nonitol, or
the trisamide-based clarifying agent is a 1,3,5-benzenetrisamide amide derivative.

11. The polymeric composition of claim 10, wherein the clarifying agent is 1,2,3-trideoxy-4,5:5,7-bis-O-[(4-propylphenyl)methylene]-Nonitol.

12. The polymeric composition of claim 1, wherein the polymeric composition comprises the at least one nucleating agent.

13. The polymeric composition of claim 12, wherein the nucleating agent is a phosphate ester based nucleating agent.

14. The polymeric composition of claim 13, wherein the nucleating agent comprises (Phosphate ester) 2,2′-methylenebis (4,6-di-tertbutylphenyl) phosphate and optionally a dispersant.

15. The polymeric composition of claim 1, wherein the polymeric composition has a melt flow index of 0.2 to 150 g/10 min as measured by ASTM D1238 (230° C./2.16 kg).

16. The polymeric composition of claim 15, wherein the polymeric composition has a melt flow index of 20-30 g/10 min, and the second polymeric composition has a melt flow index of 25-35 g/10 min.

17. The polymeric composition of claim 1, wherein the polymeric composition further comprises an additive, wherein the additive is an antioxidant, an acid neutralizer, an antistatic agent, an antiblock agent, an antifog agent, an anticorrosion agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer, a fire retardant, a mold release agent, a dye, a blowing agent, a fluorescent agent, a surfactant, or any combination thereof.

18. The polymeric composition of claim 1, wherein the polymeric composition has at least one of the following properties:
an elongation of 3% to 10%, as measured by ASTM D3218; and/or
a melting point of 140° C. to 160° C., as measured by differential scanning calorimetry (DSC); and
the second polymeric composition has at least one of the following properties:
an elongation of 10% to 15%, as measured by ASTM D638; and/or
a melting point of 150° C. to 175° C., as measured by differential scanning calorimetry (DSC).

19. The polymeric composition of claim 1, wherein the polymeric composition has a thickness of at 20 mil to 100 mil.

20. An article of manufacture comprising the polymeric composition of claim 1.

21. The article of manufacture of claim 20, wherein the article of manufacture is an injection molded article of manufacture having a thickness of 20 mil to 100 mil.

22. A method of making the article of manufacture of claim 21, the method comprising obtaining the polymeric composition of claim 1 and making the article of manufacture by injection molding, blow molding, compression molding, stretch molding, rotational molding, transfer molding, sheet extrusion thermoforming, shallow-draw thermoforming, deep-draw thermoforming, or profile extrusion.

23. A method of producing the polypropylene composition of claim 1, the method comprising:
(a) obtaining a composition comprising:
at least 95 wt. % of the polypropylene, and
a clarifying agent or a nucleating agent; and
(b) extruding the composition to obtain the polypropylene composition of claim 1.

24. The method of claim 23, wherein the extrusion conditions include a temperature of 200° C. to 260° C.
